(19) United States
(12) Patent Application Publication
(10) Pub. No.: US 2013/0052011 A1
(43) Pub. Date: Feb. 28, 2013

(54) ADVANCED WARNING SYSTEM AND METHOD FOR A TURBINE

(71) Applicant: Gawain C R Badcock, Derby (GB)

(72) Inventor: Gawain C R Badcock, Derby (GB)

(73) Assignee: ROLLS-ROYCE PLC, London (GB)

(21) Appl. No.: 13/642,267

(22) PCT Filed: Apr. 7, 2011
(86) PCT No.: PCT/EP11/55444

§ 371 Date: Oct. 24, 2012

(30) Foreign Application Priority Data
Apr. 22, 2010 (GB) 1006727.0

(51) Int. Cl. F03B 15/00

(52) U.S. Cl. 416/1; 416/36

(57) ABSTRACT

An advanced warning system for a turbine, the system comprising: one or more near-field and far-field sensors locatable remotely from the turbine and upstream of the turbine; a communication link between the turbine and the one or more near-field and far-field sensors for transmitting data from the one or more near-field and far-field sensors to the turbine; and a controller for adjusting operational settings of the turbine, wherein, in use, the controller adjusts the operational settings as a function of the received data from the one or more near-field and far-field sensors.

The present invention relates an advanced warning system and method for a turbine, and particularly but not exclusively relates to its application in marine turbines.

### BACKGROUND

Tidal power harnesses the natural energy produced by the periodic rise and fall of the sea. These tides are created by the rotation of the Earth in the presence of the gravitational fields of the Sun and Moon.

Various methods may be employed to convert the energy of the tides into useful power. These methods broadly fall into two categories: tidal stream systems and tidal barrages.

With a tidal barrage, water accumulates behind the barrage during the flood tide and is retained behind the barrage during the ebb tide until a head of water is created. Once the head of stored water is of sufficient height, the stored water is released and directed to flow through turbines housed within the barrage, thus converting the potential energy stored in the water into useful power.

Tidal stream systems operate in a similar manner to wind turbines and usually consist of a turbine which is rotated by the tidal current. Water has a density which is 800 times that of air and therefore marine turbines are capable of extracting a comparable power to that of a wind turbine at much lower fluid speeds. However, to date, marine turbines are not yet in widespread service.

It is known to provide wind turbines with a reactive control system which detects wind speed at the turbine and, when the wind speed exceeds a predetermined upper limit, shuts the turbine down so as to protect the turbine from being damaged by the high winds. This increases the safety of the turbine since, in the event of a failure of the turbine, debris may be released from the turbine which could potentially cause damage to nearby infrastructure and people.

FIG. 1 shows a marine turbine 2 utilising such a reactive control system (not shown). The turbine 2 comprises a rotor 4 having a number of blades 6 which rotate under the influence of the passing water (indicated by arrows 8). The reactive control system monitors the rate of rotation of the rotor 4 and controls the pitch of the blades 6 to maintain an approximately constant power output from the generator (not shown) of the turbine 2. Alternatively, the control system may vary the load on the generator so as to maintain a constant power output.

FIG. 2 shows a graph of the bulk average water speed as a function of time during the ebb or flood component of the tidal cycle (indicated by the solid line 10). The tidal current changes direction as it crosses the time axis of this graph (i.e. slack water, indicated at 12) and the water speed increases from slack water to the midpoint 14 of the tide where it reaches a maximum value. Following the midpoint 14, the water speed decreases as the tidal current progresses to the next slack water 12. The bulk average water speed therefore follows an approximately sinusoidal pattern. However, as shown by the enlarged portion of this graph, on a shorter time scale, the water speed varies from this generally sinusoidal form.

The graph of FIG. 2 also shows the resulting power output of the generator of the turbine 2 using the reactive control system described above. For the turbine 2 to operate effectively it requires the water speed to be greater than a predetermined minimum value. Therefore, as shown in FIG. 2, the turbine 2 has a minimum cut-in speed 16 as the water speed increases from slack water 12 and a minimum cut-out speed 16 as the water speed decreases towards slack water 12.

Once the water speed has reached the minimum cut-in speed 16, the turbine is activated and the generator produces power from the tidal current as indicated by the region 20. The turbine 2 has a predetermined safe running limit 22 (which is the normal working level of the turbine 2) and the reactive control system is configured to prevent the power output of the generator from exceeding this limit. Therefore, as the tidal current reaches sufficient speed to produce a power that would exceed the safe running limit 22, the reactive control system is invoked and is used to control the operational settings of the turbine so as to limit the power produced. This is achieved by adjusting the pitch of the blades 6 or by adjusting the load on the generator, as described above.

As the water speed decreases following the midpoint 14, the reactive control system must adjust the operational settings so as to capture a greater proportion of the water's energy. There is a time lag, indicated at 24, between the reactive control system detecting the reduction in water speed and the reactive control system adjusting the operational settings accordingly. Therefore, the turbine 2 is not maintained at the safe running limit 22 at all times and the captured power is reduced as a result.

The safe running limit 22 is set at a level which allows sufficient time (response time 25) for the reactive control system to adjust the operational settings of the turbine so as to prevent the power exceeding a maximum normal working limit 26 if an extreme event occurs. The maximum working limit is determined by the rate of rotation of the rotor 4, stress experienced by the turbine 2, the temperature, current or voltage of the generator of the turbine 2, etc.

Such an extreme event is shown in FIG. 3. The extreme event 28 creates a temporary surge in power but is contained by the reactive control system which adjusts the operational settings of the turbine to counteract the surge. Since the safe running limit 22 is set at a level which allows sufficient time for the reactive control system to react, the power is prevented from exceeding the maximum normal working limit 26 and the turbine 2 is not damaged by the extreme event 28.

FIG. 4 shows a failure event 30 which is of greater magnitude than the extreme event 28 of FIG. 3. The failure event 30 is too great to be controlled by adjusting the operational settings of the turbine using the reactive control system. Consequently, it is necessary to invoke an emergency safety system which shuts the turbine 2 down before it reaches a maximum possible load 32. The maximum possible load 32 is determined by the yield strength of the turbine 2 and therefore reaching this limit, or even approaching it, risks serious damage to the turbine 2.

The prior art reactive control system does not fully utilise the water's energy as a result of the time lag 24 described above. Furthermore, it is necessary for the safe running limit 22 to be sufficiently lower than the maximum normal working limit to allow for the response time of the reactive control system. The power captured by the turbine 2 is therefore reduced by the response time of the reactive control system. Moreover, the reactive control system risks serious damage being caused to the turbine 2 as it is unable to cope with failure events.

The present invention provides an system which solves or alleviates some or all of the above addressed problems.

### STATEMENTS OF INVENTION

In accordance with an aspect of the invention, there is provided an advanced warning system for a turbine, the system comprising: one or more near-field and far-field sensors which, in use, are located remotely from the turbine and upstream of the turbine; a communication link between the turbine and the one or more near-field and far-field sensors for transmitting data from the one or more near-field and far-field sensors to the turbine; and a controller for adjusting operational settings of the turbine, wherein, in use, the controller adjusts the operational settings as a function of the received data from the one or more near-field and far-field sensors.

The operational settings of the turbine may include blade pitch and/or generator load.

The one or more near-field sensors may sense operating conditions of another turbine.

The one or more near-field sensors may include one or more of: a strain gauge, an acoustic Doppler current profiler, a pressure sensor, a temperature sensor, a vibration sensor, a velocity sensor, a rotation speed sensor, a generator power output sensor, and a generator quality sensor.

The controller may comprise a primary controller and a secondary controller, and wherein, in use, the secondary controller may adjust the operational settings of the turbine in the event of a fault with the primary controller.

The advanced warning system may further comprise a safety shutdown command module which, in use, shuts the turbine down when a fault is detected or a safety limit is exceeded.

The advanced warning system may further comprise a communication link with an external monitoring station for transmitting data from the one or more near-field and far-field sensors and/or controller.

The external monitoring station may be a turbine service desk, weather information provider or sea state information provider.

The far-field sensors may include seastate sensing equipment. The far-field sensors may include one or more buoys.

The turbine may be a marine turbine.

The advanced warning system may be used in a turbine farm comprising the advanced warning system and a plurality of turbines; wherein, in use, the controller of the advanced warning system adjusts the operational settings of one or more of the plurality of turbines.

The one or more sensors may be located on one or more of the plurality of turbines. Data from the one or more near-field and far-field sensors and/or controller may be transmitted to another turbine farm.

The plurality of turbines may be marine turbines.

In accordance with another aspect of the invention, there is provided a method of providing an advanced warning for a turbine, the method comprising: sensing predetermined parameters at a plurality of locations upstream of the turbine with far-field and near-field sensors; transmitting the sensed data to the turbine; and controlling operational settings of the turbine as a function of the received data.

Sensing predetermined parameters may include sensing parameters of another turbine.

The method may further comprise shutting the turbine down when the sensed parameters indicate a fault or that a safety limit has been exceeded.

### BRIEF DESCRIPTION OF THE DRAWINGS

For a better understanding of the present invention, and to show more clearly how it may be carried into effect, reference will now be made, by way of example, to the accompanying drawings, in which:

FIG. 1 is a side schematic view of a prior art turbine and a reactive control system;

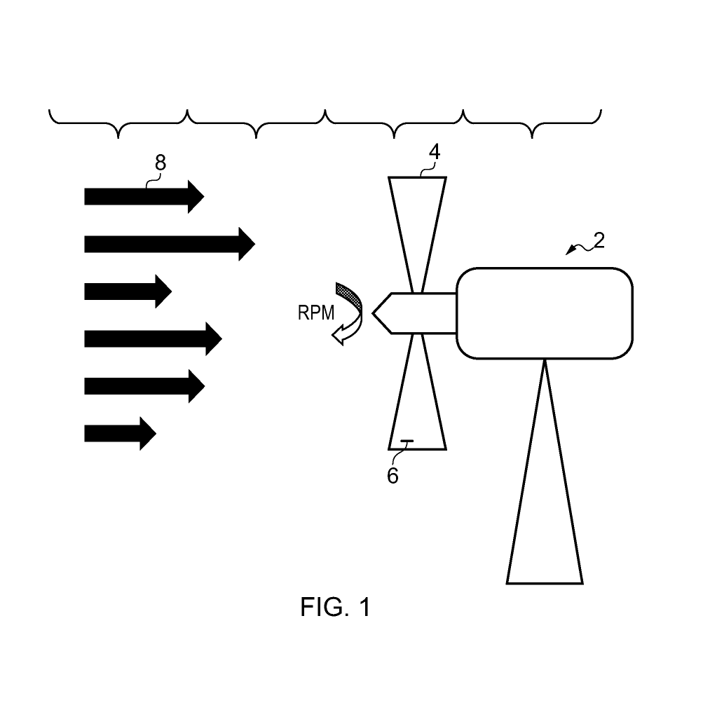

FIG. 2 is a graph of the power captured by the turbine of FIG. 1 during the ebb or flood component of a tide cycle;

FIG. 3 is a graph of the power captured by the turbine of FIG. 1 during an extreme event;

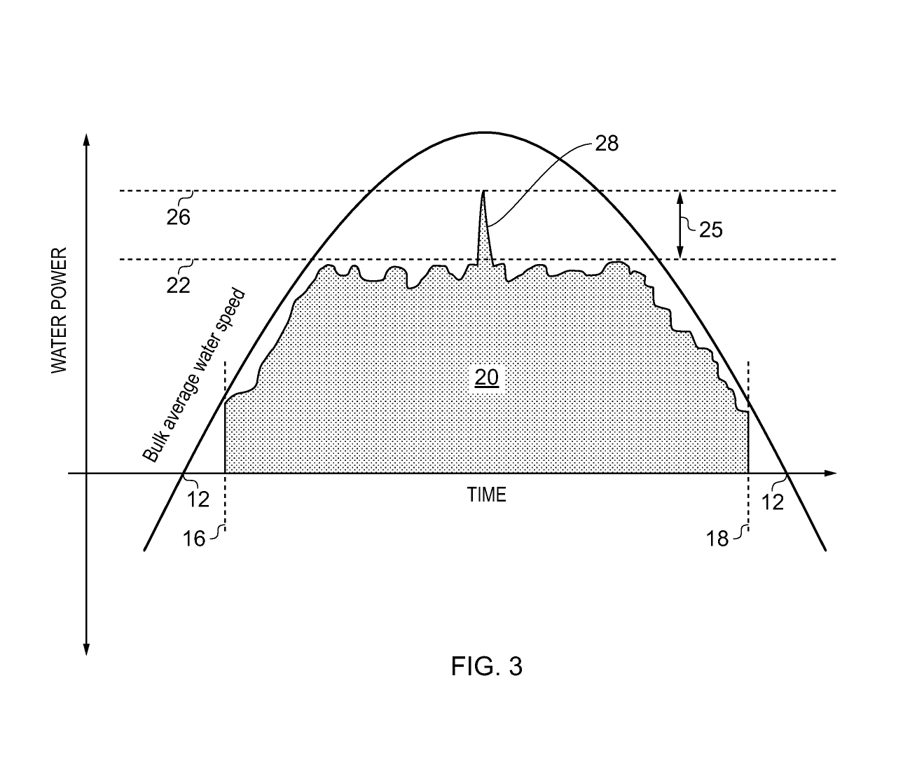

FIG. 4 is a graph of the power captured by the turbine of FIG. 1 during a failure event;

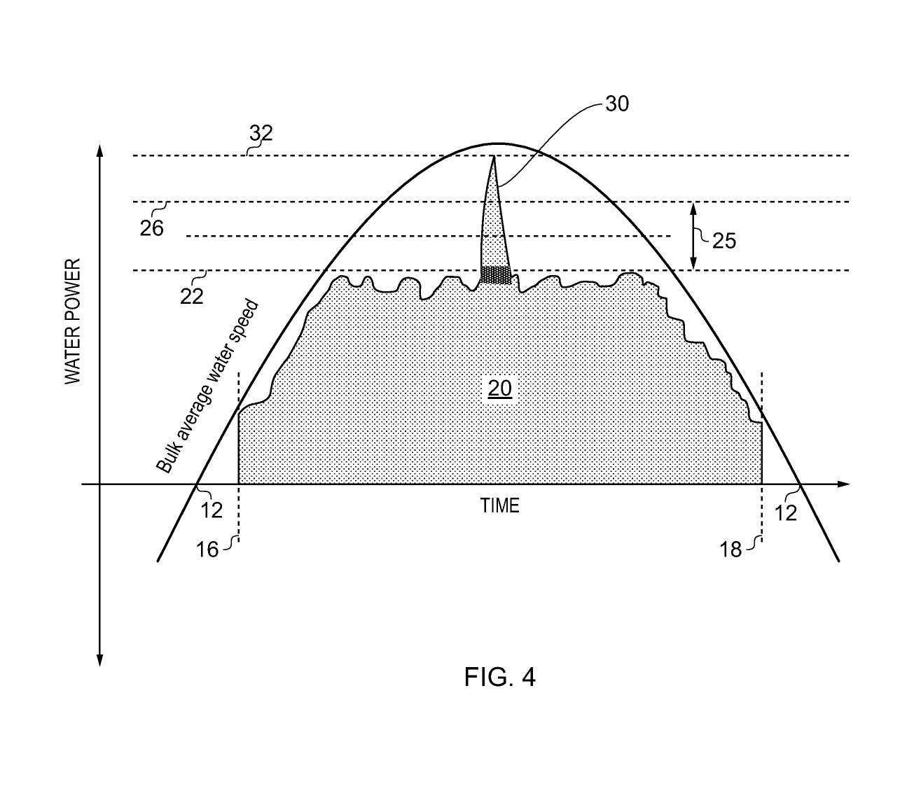

FIG. 5 is a side schematic view of an upstream turbine and a downstream turbine utilising an advanced warning system in accordance with an embodiment of the invention;

FIG. 6 is a schematic organizational view of the control system of the downstream turbine;

FIG. 7 is a schematic organizational view of the downstream turbine and its interaction with other turbines;

FIG. 8 is a perspective schematic view of a turbine farm using the advanced warning system during an extreme flow event;

FIG. 9 is a graph of the power captured by the turbine using the advanced warning system during the ebb or flood component of a tide cycle;

FIG. 10 is a graph of the power captured by the turbine using the advanced warning system during an extreme flow event;

FIG. 11 is a graph of the power captured by the turbine using the advanced warning system during a failure event; and

FIG. 12 is a plan view of another embodiment of the advanced warning system.

### DETAILED DESCRIPTION

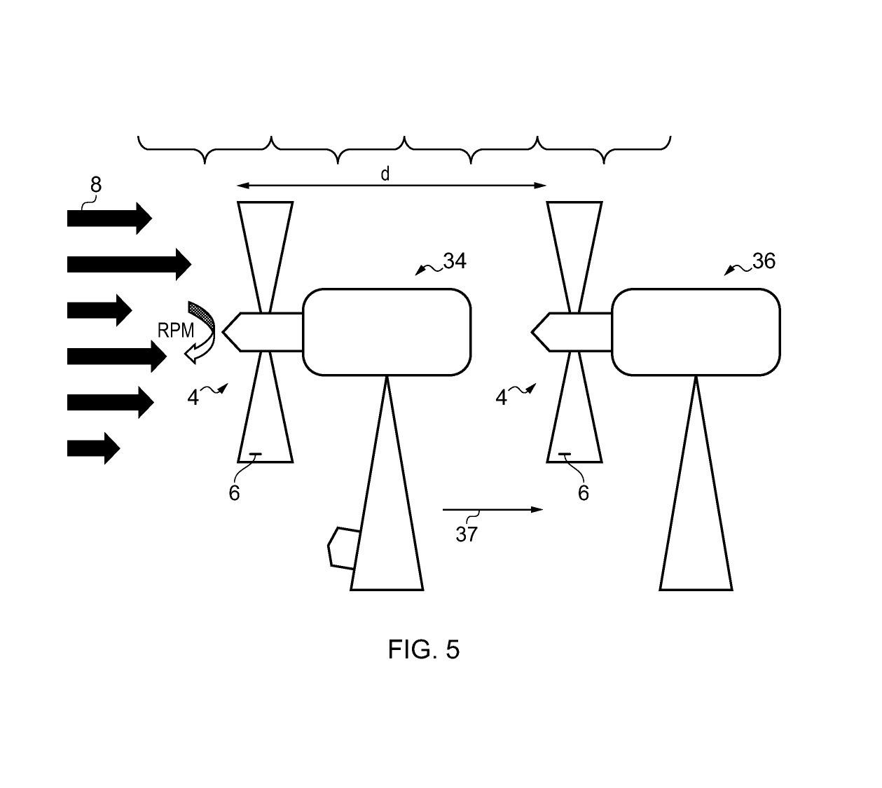

FIG. 5 shows an advanced warning system in accordance with an embodiment of the invention. The advanced warning system comprises an upstream turbine 34 and a downstream turbine 36. The upstream turbine 34 and downstream turbine 36 are separated by a distance d, with the upstream turbine 34 located at a position which is upstream of the downstream turbine 36 with respect to the tidal current 8. Therefore water passes the upstream turbine 34 and subsequently flows to the downstream turbine 36. The upstream turbine 34 comprises one or more sensors which provide information regarding the tidal current either directly from the water itself or indirectly from the operating conditions of the upstream turbine 34.

The one or more sensors include one or more of: a strain gauge, an acoustic Doppler current profiler, a pressure sensor, a temperature sensor, a vibration sensor, a velocity sensor, a rotation speed sensor, a generator power output sensor, and a generator quality sensor. However, other sensors may be used which provide useful information regarding the present conditions.

The upstream turbine 34 and downstream turbine 36 are connected by a communication link 37. This may be a wired or wireless communication channel which at least allows information to be transmitted from the upstream turbine 34 to the downstream turbine 36.

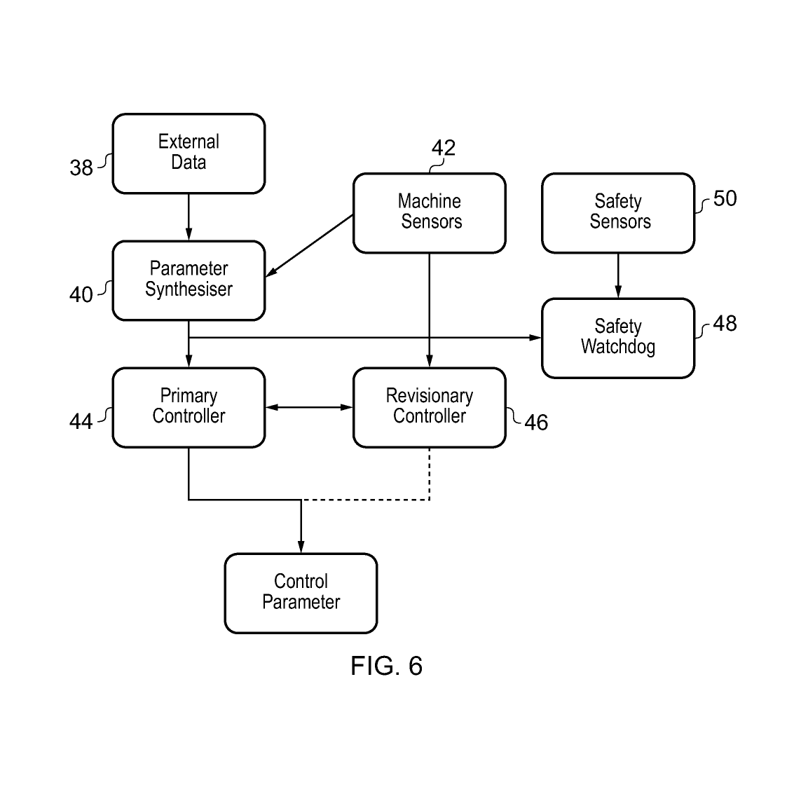

The upstream turbine 34 transmits data from the one or more sensors to the downstream turbine 36 via the communication link 37. As shown in FIG. 6, the external data 38 is received by the downstream turbine 36 and is passed to a parameter synthesiser 40. The parameter synthesiser 40 also receives an input from one or more machine sensors 42 which monitor the current operational settings of the downstream turbine 36. The parameter synthesiser 40 assesses the current operational settings and the received data from the upstream turbine 34 to determine the optimum operational settings for the approaching tidal current. This information is relayed to a primary controller 44.

A revisionary controller 46 is also provided which receives an input from the one or more machine sensors 42. The primary controller 44 compares the received information with the revisionary controller 46 and determines whether the operational settings of the downstream turbine 36 need to be adjusted. If this is the case, the primary controller 44 effects the adjustment of the operational settings. The revisionary controller 46 is also able to control the operational settings in the event of a failure which prevents the primary controller 44 from doing so.

It is to be clarified that a ‘failure’ in the context of the present invention encompasses a situation in which a machine or component thereof operates outside of predetermined safe or intended operating conditions. Such an event includes, but is not limited, to the actual mechanical or electrical failure of a machine component or assembly. It also encompasses an instance in which use of the component or assembly is deemed unsafe or detrimental to future operation even though the machine is operable in the short term.

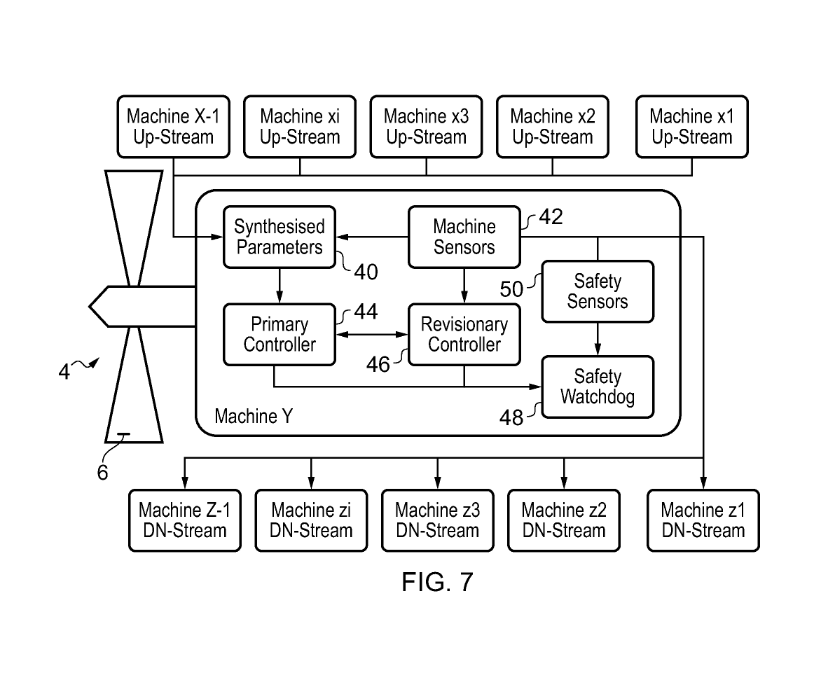

A safety “watchdog” 48 is provided which monitors safety sensors 50. The safety sensors 50 provide information regarding conditions in the downstream turbine 36, for example the temperature of the generator, stress on the turbine, vibration levels, etc. When any of these parameters reach dangerous levels the safety watchdog 48 is invoked and commands a safety shutdown of the downstream turbine 36. The safety watchdog 48 also monitors the input and/or output (see FIG. 7) of the primary controller 44. If the safety watchdog 48 detects that there is a fault which may result in the operational settings of the downstream turbine 36 not being correctly adjusted, the safety watchdog 48 again commands a safety shutdown of the downstream turbine 36.

FIG. 7 shows how the advanced warning system is applied to a turbine farm comprising a plurality of turbines. As shown, the turbine Y receives advanced warning information from a plurality of upstream turbines X which is used to control the operational settings of the turbine Y as described above in reference to FIG. 6. Furthermore, the turbine Y transmits its own data (and possibly data of the preceding upstream turbines X) to a plurality of downstream turbines Z which use this data to control their operational settings.

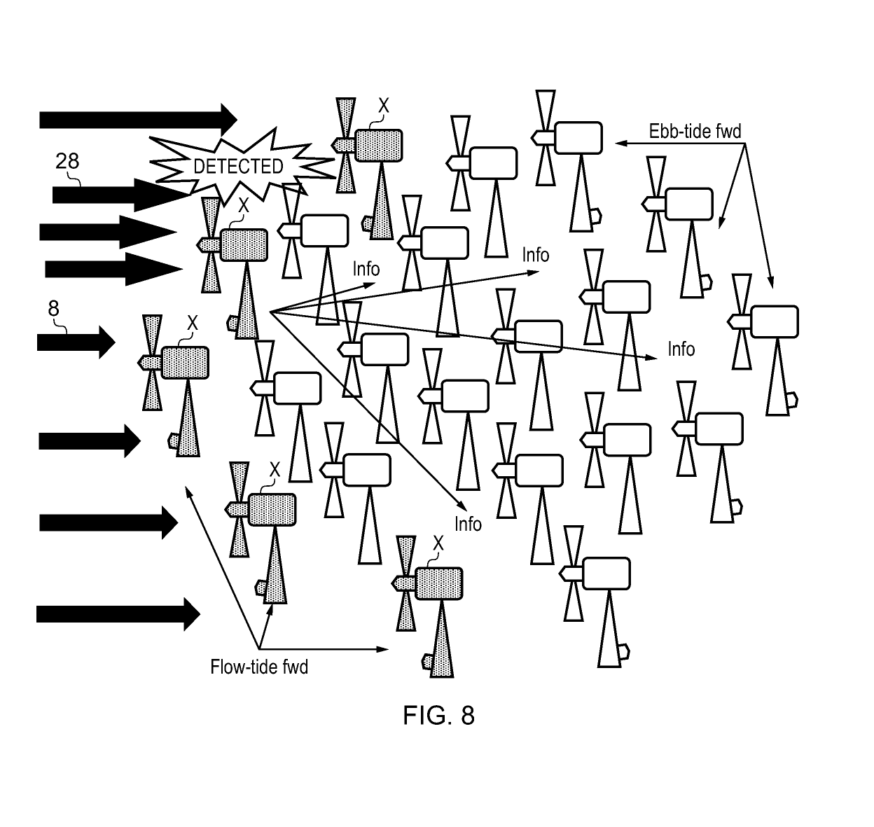

FIG. 8 shows a perspective view of the turbine farm. As shown, one of the upstream turbines X detects an extreme event and this information is relayed to the downstream turbines.

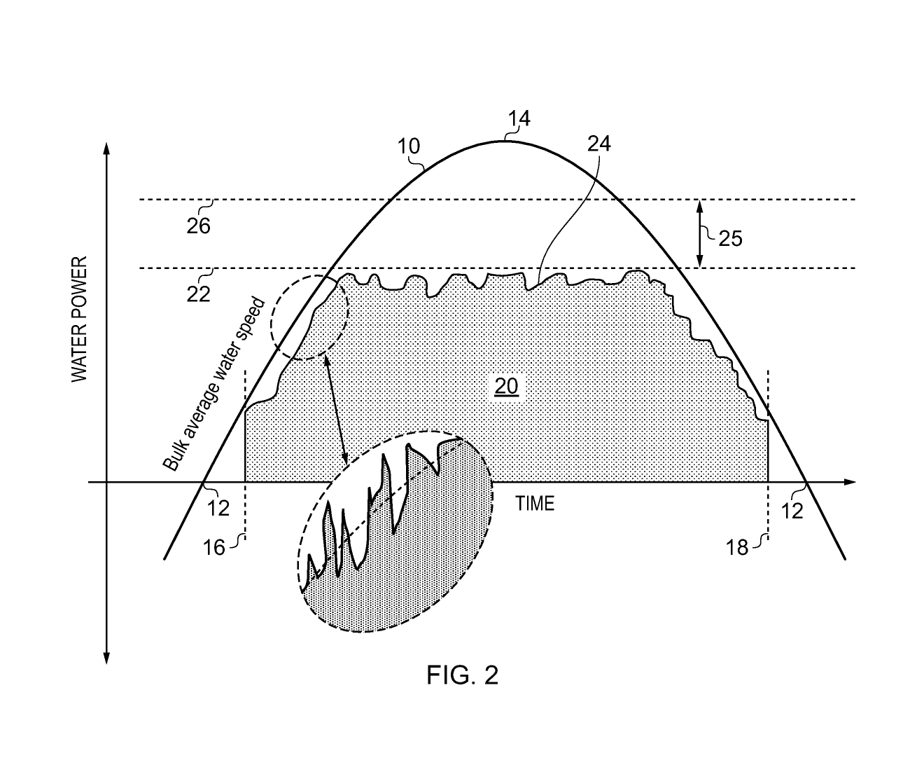

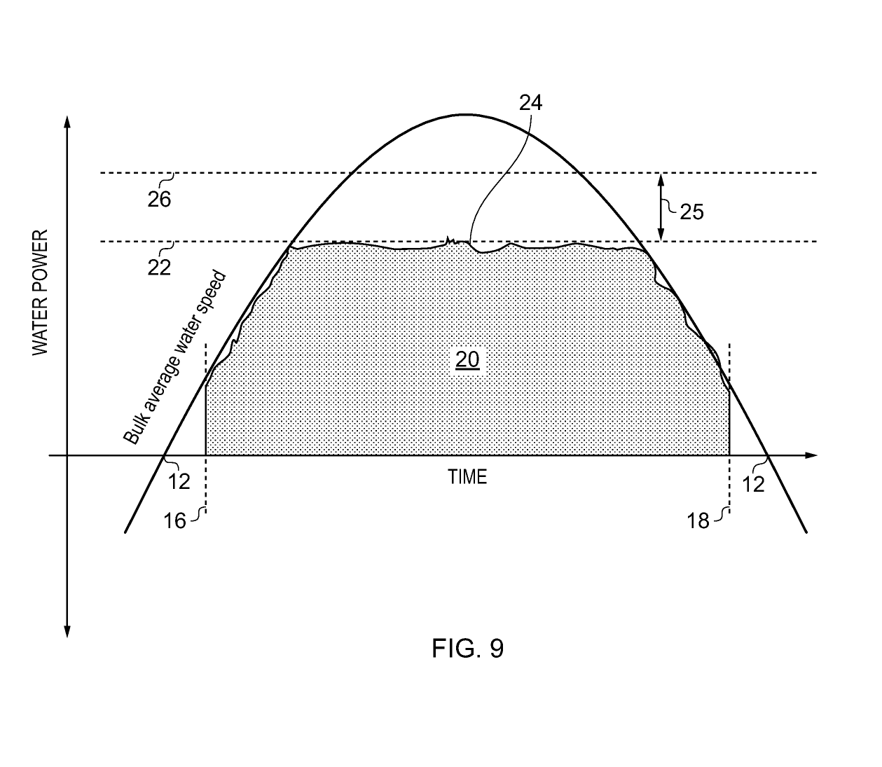

FIG. 9 is analogous to FIG. 2 but for the advanced warning system and shows a graph of the bulk average water speed as a function of time during the ebb or flood component of the tidal cycle and the resulting power output of the generator of the downstream turbine 36 using the advanced warning system.

Like the turbine 2, the advanced warning system is configured to prevent the power output of the generator from exceeding the predetermined safe running limit 22. However, since the downstream turbine 36 is actively controlled, the adjustment of the operational settings of the turbine can be effected as the tidal current arrives at the downstream turbine 36. This removes the time lag 24 experienced with the prior art reactive control system. Therefore, the downstream turbine 36 can be maintained at the safe running limit 22 at all times and the captured power is increased as a result.

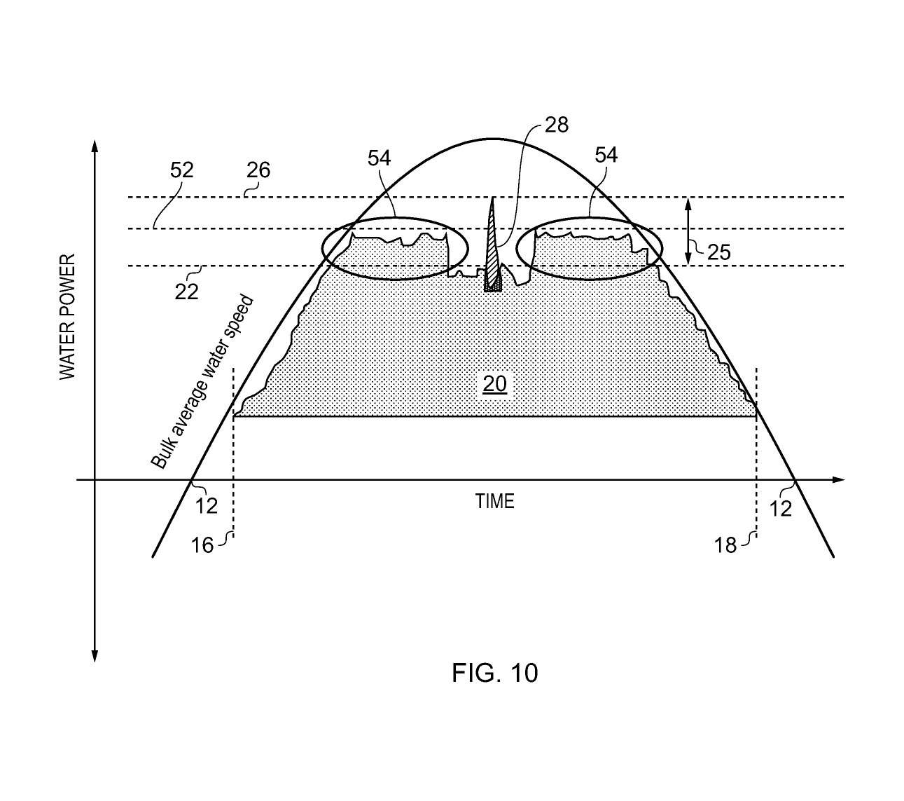

Furthermore, since the advanced warning system effectively removes the response time requirement, it is possible to operate the downstream turbine 36 at a higher safe running limit 52, as shown in FIG. 10, without exceeding the maximum normal working limit 26 if an extreme event 28 occurs. When the upstream turbine 34 detects the extreme event 28, the operational settings of the downstream 26 are adjusted to reduce the power to the lower safe running limit 22. This prevents the power from exceeding the maximum normal working limit 26. In addition, since the downstream turbine 36 is able to operate predominantly at the higher safe running limit 52, it is possible to capture more power from the tidal current using the advanced warning system, as shown in the regions 54.

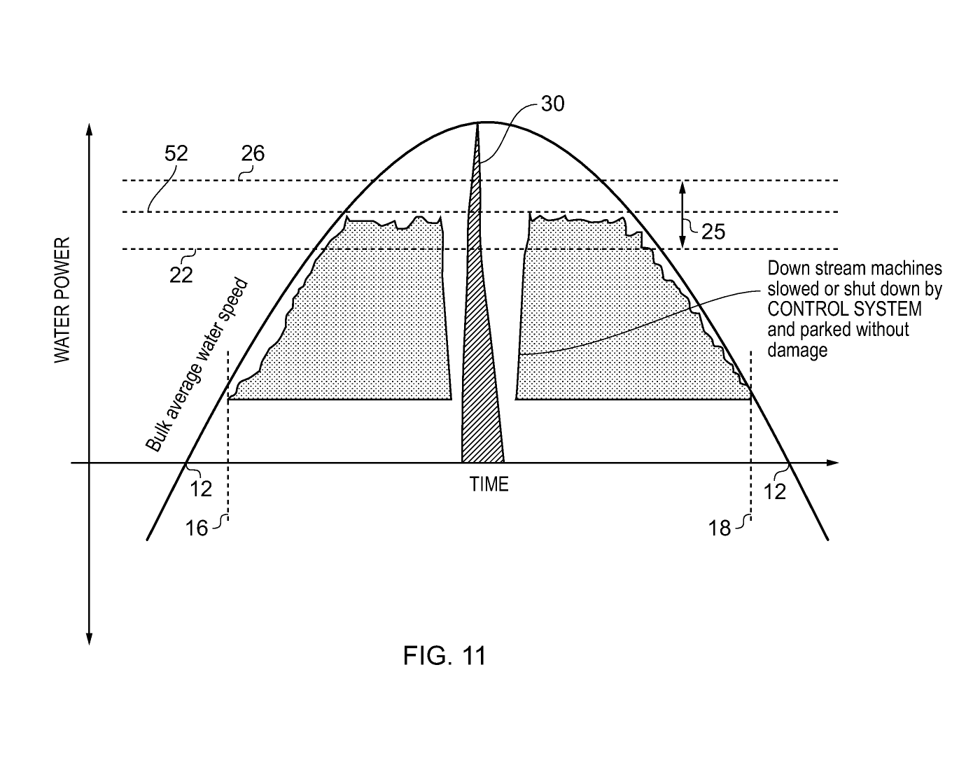

Moreover, if a failure event 30 is detected, the advanced warning system is able to shutdown the downstream turbine 36 prior to the failure event 30 arriving at the downstream turbine 36, as shown in FIG. 11. Therefore, the downstream turbine 36 avoids the failure event and thus the advanced warning system prevents serious damage being caused to the downstream turbine 36.

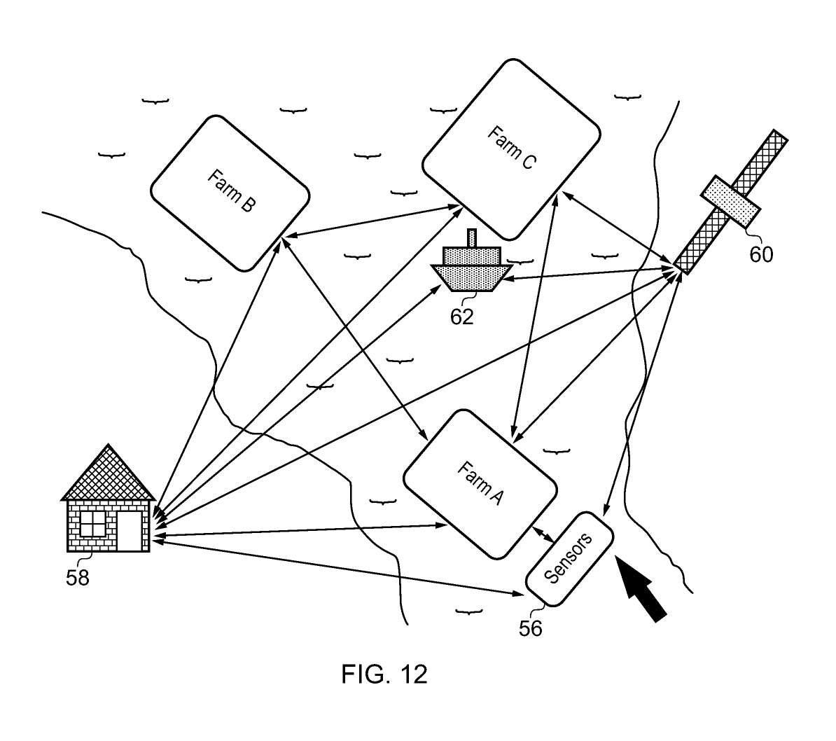

In the embodiment shown in FIG. 5, the upstream turbine 34 may be controlled using a reactive control system since it does not receive information from an upstream location. FIG. 12 shows an alternative embodiment which ensures that all turbines in the turbine farm receive advanced warning system. In the embodiment of FIG. 12, one or more sensors 56 are provided at a location which is upstream of the turbine farm A. Therefore, all of the turbines in the turbine farm A receive data from the one or more sensors 40 and thus receive advanced warning of approaching tidal conditions. Furthermore, data from the one or more sensors 56 and/or turbine farm A is communicated to further turbine farms B and C located downstream of the turbine farm A. The data from the one or more sensors 56 and turbines farms A-C may also be transmitted to an external monitoring station, such as a turbine service desk 58 or satellite 60. The service desk 58 is a station for monitoring the turbine farms A-C over a longer period of time and is used to monitor the performance of the turbines and to schedule any required maintenance.

Sensed or predicted data which may affect flow conditions in the vicinity of the turbine may be transmitted first to the monitoring station where it may be processed prior to transmismittal of processed or derived data to the individual turbines. Thus the monitoring station may receive a variety of data from a plurality of sources and may transmit only a more limited subset of data or instructions to the individual turbines. A combination of processing steps may be carried out by the monitoring station and/or turbines as appropriate. However in one particular embodiment, it is preferred that the monitoring station performs the data processing and analysis steps such that only relatively small amounts of reporting data or instructions are transmitted to each individual turbine. This carries the additional benefit that the monitoring station software can be updated easily without the need to update each turbine to accommodate new data analysis algorithms, different types or sources of data and/or other software updates.

The satellite 60 may be of a weather information provider or a sea state information provider and the received information can be used to provide weather or sea state reports to ships 62 or the like, or to a land based receiver, particularly to signal an approaching tsunami.

In one embodiment, the sensing equipment may be located a distance upstream of a turbine or turbine array/farm and may take the form of one or more seastate sensing buoys or equivalent equipment. Such equipment may be controlled or operated by the turbine operator such that the buoy can be located optimally in relation to a turbine array. Thus the operational settings of even the most upstream turbine in an array can be adjusted immediately prior to the onset of varying flow conditions—such as, for example, adverse or extreme flow conditions—in order to adjust operational settings to achieve optimal power efficiency and/or avoid occurrence of a failure event.

Such sensing equipment may be optimally located such that the turbine control systems have sufficient time to react to conditions sensed by the equipment.

Such sensing equipment may be used in conjunction with the other described information sources so as to provide both a far-field and near-field sensing capability. This combination of sensing capabilities may improve the reliability of sensed conditions and the effectiveness by which the one or more turbines are operated.

Such equipment may be particularly beneficial to hydrokinetic turbines since the nature of tidal flow can cause isolated and/or temporary flow patterns which may or may not impinge on the turbine(s) under operation. Accordingly the present invention may account for general or prevailing (such as, far-field) flow conditions and/or local flow conditions as necessary.

It is to be noted that the communication links between the one or more turbines and the tidal condition or weather information supplier may be bi-directional such that tidal turbine or array can operate as a sea-state sensing system and can provide information concerning the conditions experienced by the turbine back to the information provider, the service desk or other recipient over a suitable network.

The control strategy to be used in response to sensed flow conditions will prioritise the operational safety of the turbine, followed by the optimisation of the power output from the oncoming flow.

The present invention may operate during either flood or ebb tide and accordingly those turbines which are described as being upstream become downstream during the alternative tide and vice versa.

Although the present invention has been described with reference to marine turbines, it may also be applicable to wind turbines.

To avoid unnecessary duplication of effort and repetition of text in the specification, certain features are described in relation to only one or several aspects or embodiments of the invention. However, it is to be understood that, where it is technically possible, features described in relation to any aspect or embodiment of the invention may also be used with any other aspect or embodiment of the invention.

1. An advanced warning system for a hydrokinetic turbine, the system comprising:
one or more near-field and far-field sensors locatable remotely from the turbine and upstream of the turbine for sensing one or more variables which may affect flow conditions in the vicinity of the turbine;
a communication link between the turbine and the one or more near-field and far-field sensors for transmitting data from the one or more near-field and far-field sensors or data derived there-from to the turbine; and
a controller for adjusting operational settings of the turbine, wherein, in use, the controller adjusts the operational settings as a function of the data from the one or more near-field and far-field sensors.

2. An advanced warning system as claimed in claim 1, wherein the operational settings of the turbine include blade pitch and/or generator load.

3. An advanced warning system as claimed in claim 1, wherein the one or more near-field sensors sense operating conditions of another turbine.

4. An advanced warning system as claimed in claim 1, wherein the one or more near-field sensors include one or more of: a strain gauge, an acoustic Doppler current profiler, a pressure sensor, a temperature sensor, a vibration sensor, a velocity sensor, a rotation speed sensor, a generator power output sensor, and a generator quality sensor.

5. An advanced warning system as claimed in claim 1, wherein the controller comprises a primary controller and a secondary controller, and wherein, in use, the secondary controller adjusts the operational settings of the turbine in the event of a fault with the primary controller.

6. An advanced warning system as claimed in claim 1, further comprising a safety shutdown command module which, in use, shuts the turbine down when a fault is detected or a safety limit is exceeded.

7. An advanced warning system as claimed in claim 1, further comprising a communication link with an external monitoring station for transmitting data from the one or more near-field and far-field sensors and/or controller.

8. An advanced warning system as claimed in claim 7, wherein the external monitoring station is a turbine service desk, weather information provider or sea state information provider.

9. An advanced warning system as claimed in claim 1 wherein the one or more far field sensors include seastate information sensors.

10. An advanced warning system as claimed in claim 1 wherein the one or more far field sensors include at least one bouy.

11. An advanced warning system as claimed in claim 1 wherein the one or more far-field sensors include weather sensing equipment.

12. A turbine comprising the advanced warning system as claimed in claim 1.

13. A turbine as claimed in claim 1, wherein the turbine is a marine turbine.

14. A hydrokinetic turbine farm, comprising:
an advanced warning system as claimed in any one of the preceding claims; and
a plurality of hydrokinetic turbines;
wherein, in use, the controller of the advanced warning system adjusts the operational settings of one or more of the plurality of turbines.

15. A turbine farm as claimed in claim 14, wherein the one or more sensors are located on one or more of the plurality of turbines.

16. A turbine farm as claimed in claim 14, wherein data from the one or more sensors and/or controller is transmitted to another turbine farm.

17. A turbine farm as claimed in claim 14, wherein the plurality of turbines are marine turbines.

18. A method of providing an advanced warning for a hydrokinetic turbine, the method comprising:
sensing predetermined parameters at a location upstream of the turbine using one or more near-field and far-field sensors;
transmitting the sensed data or data derived there-from to the turbine; and
controlling operational settings of the turbine as a function of the received data.

19. A method as claimed in claim 18, wherein sensing predetermined parameters includes sensing parameters of another turbine.

20. A method as claimed in claim 18, further comprising shutting the turbine down when the sensed parameters indicates a fault or that a safety limit has been exceeded.
